(19) United States
(12) Patent Application Publication
(10) Pub. No.: US 2022/0060093 A1
(43) Pub. Date: Feb. 24, 2022

(54) MANUFACTURING METHOD OF STATOR

(71) Applicant: SUBARU CORPORATION, Tokyo (JP)

(72) Inventor: Kenichi FUKUNAGA, Tokyo (JP)

(21) Appl. No.: 17/390,357

(22) Filed: Jul. 30, 2021

(30) Foreign Application Priority Data
Aug. 19, 2020 (JP) 2020-138341

(51) Int. Cl. H02K 15/06; H02K 15/00; H02K 15/02; H02K 15/12

(52) U.S. Cl. CPC H02K 15/064; H02K 15/12; H02K 15/024; H02K 15/0081

(57) ABSTRACT

A method of manufacturing a stator of a rotary electric machine includes heating a stator core so as to expand the stator core. The stator core has a hollow cylindrical shape and includes slots. The method includes inserting conductor groups in the slots of the heated stator core. The conductor groups each include segment conductors. The method includes cooling the stator core where the conductor groups are inserted so as to provide an interference between each of the slots and a corresponding one of the conductor groups.

### CROSS-REFERENCE TO RELATED APPLICATIONS

The present application claims priority from Japanese Patent Application No. 2020-138341 filed on Aug. 19, 2020, the entire contents of which are hereby incorporated by reference.

### BACKGROUND

The disclosure relates to a manufacturing method of a stator of a rotary electric machine.

A rotary electric machine, such as an electric motor and a generator, includes a stator wound with a stator coil (see Japanese Unexamined Patent Application Publication (JP-A) No. 2013-9499, JP-A No. 2012-44831, JP-A No. 2012-170311, JP-A No. 2016-82624, and JP-A No. 2018-117402). As the stator coil wound on the stator, there is proposed a stator coil including plural segment coils bent substantially in a U shape.

### SUMMARY

An aspect of the disclosure provides a method of manufacturing a stator for a rotary electric machine. The method includes heating a stator core so as to expand the stator core. The stator core has a hollow cylindrical shape, and includes slots. The method includes inserting conductor groups in the slots of the heated stator core. The conductor groups each include segment conductors. The method includes cooling the stator core where the conductor groups are inserted so as to provide an interference between each of the slots and a corresponding one of the conductor groups.

### BRIEF DESCRIPTION OF THE DRAWINGS

The accompanying drawings are included to provide a further understanding of the disclosure and are incorporated in and constitute a part of this specification. The drawings illustrate example an embodiment and, together with the specification, serve to explain the principles of the disclosure.

FIG. 1 is a cross-sectional view of an exemplary rotary electric machine including a stator.

FIG. 2 is a cross-sectional view of the stator taken along line A-A in FIG. 1.

FIG. 3 is a cross-sectional view of a stator core including a U-phase coil.

FIG. 4 is a perspective view of an example of a segment coil.

FIG. 5 is a perspective view of the stator.

FIGS. 6A and 6B are diagrams illustrating an example of a coupling state of the segment coils.

FIG. 7 is a diagram illustrating an example of a connection state of a stator coil.

FIG. 8 is a flowchart of an example of a manufacturing method of the stator.

FIG. 9 is a diagram illustrating how a core heating step is performed.

FIG. 10A is a partial enlarged view illustrating how a coil insertion step is performed. FIG. 10B is a partial enlarged view illustrating how a core cooling step is performed.

FIG. 11 is a partial enlarged view illustrating dimensions of a slot and a coil group as single bodies in a normal-temperature environment.

FIG. 12 is a partial enlarged view of the slot and the coil group held in this slot in the normal-temperature environment.

### DETAILED DESCRIPTION

Segment coils that constitute a stator coil are held in plural slots formed in a stator core. In manufacturing a stator, varnish is filled in a gap between each of the slots and a respective one of the segment coils. This varnish is cured to secure the segment coils in the stator core. However, securing the segment coils with the varnish is a cause of deviating a natural frequency of the stator. That is, it is difficult to spread the varnish through entire inside areas of the slots, and the segment coils are not uniformly secured at predetermined positions with the varnish. Consequently, manufactured stators have a deviation in natural frequency. In this manner, the deviation in the natural frequency of the stator causes difficulty in designing a whole motor so that there is a demand for stabilizing the natural frequency of the manufactured stators.

It is desirable to stabilize a natural frequency of a manufactured stator.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

In the following description, as an exemplary rotary electric machine 11 including a stator 10, a three-phase alternating current synchronous motor-generator mounted on an electric vehicle, a hybrid vehicle, and other vehicles will be given. However, this is not to be construed in a limiting sense. Any rotary electric machine may be applied insofar as the rotary electric machine includes the stator 10 where segment coils 40 are assembled.

### Configuration of Rotary Electric Machine

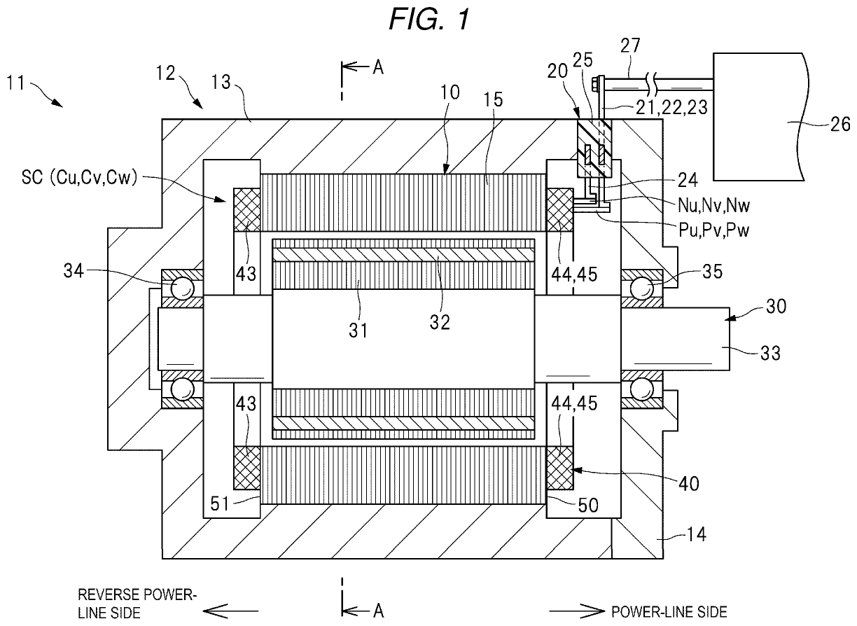

FIG. 1 is a cross-sectional view of an example of the rotary electric machine 11 including the stator 10. As illustrated in FIG. 1, the rotary electric machine 11 is a motor-generator and includes a motor housing 12. The motor housing 12 includes a housing body 13 of a bottomed, hollow cylindrical shape, and an end cover 14 that closes an open end of the housing body 13. The stator 10 is secured in the housing body 13 and includes a stator core 15 of a hollow cylindrical shape including plural silicon steel sheets, for example, and a three-phase stator coil SC wound on the stator core 15. In one example, the stator coil SC may serve as a “stator winding”.

A bus bar unit 20 is coupled to the stator coil SC. This bus bar unit 20 includes three power bus bars 21, 22, and 23 coupled to three power points Pu, Pv, and Pw of the stator coil SC, a neutral bus bar 24 that couples three neutral points Nu, Nv, and Nw of the stator coil SC to one another, and an insulating member 25 to hold these bus bars 21 to 24. End portions of the power bus bars 21 to 23 protrude outward from the motor housing 12, and a power cable 27 extending from an inverter 26 is coupled to each of the power bus bars 21 to 23.

A rotor 30 of a solid cylindrical shape is rotatably accommodated in a center of the stator core 15. This rotor 30 includes a rotor core 31 of a hollow cylindrical shape including plural silicon steel sheets, for example, plural permanent magnets 32 buried in the rotor core 31, and a rotor shaft 33 secured in a center of the rotor core 31. One end of the rotor shaft 33 is supported by a bearing 34 disposed on the housing body 13, and the other end of the rotor shaft 33 is supported by a bearing 35 disposed on the end cover 14.

### Configuration of Stator

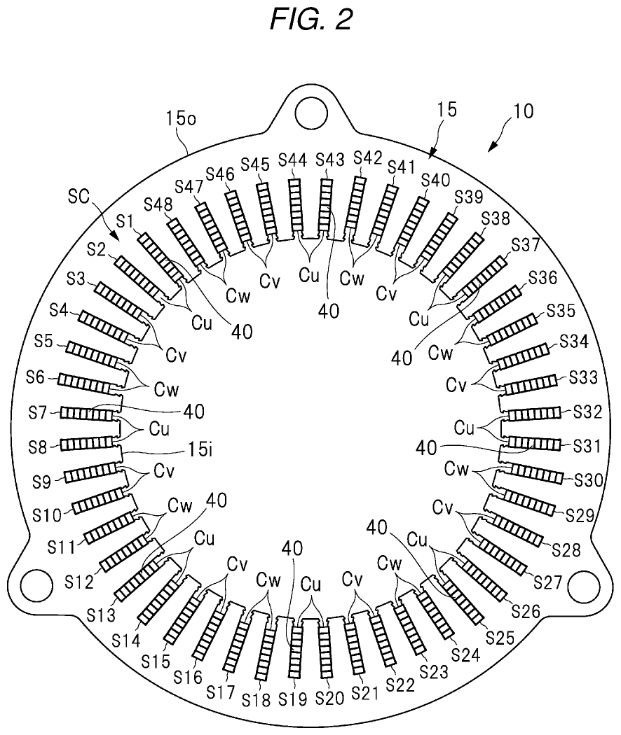

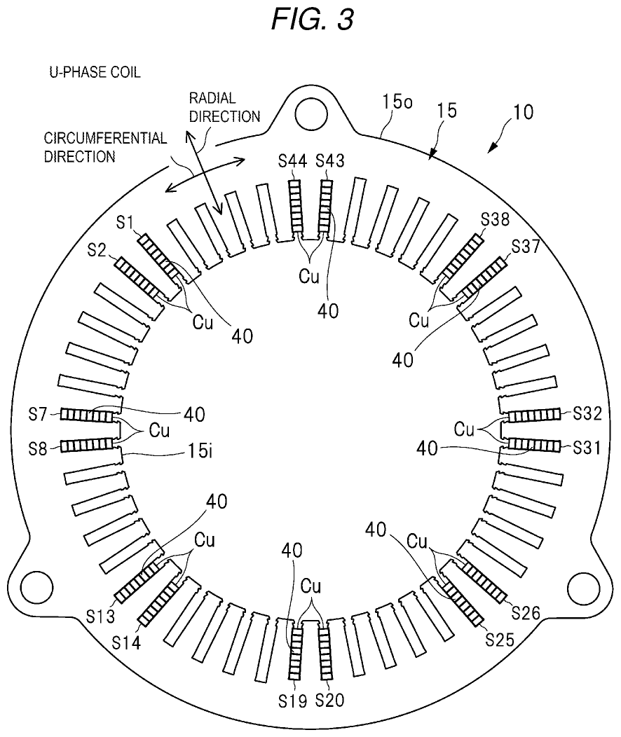

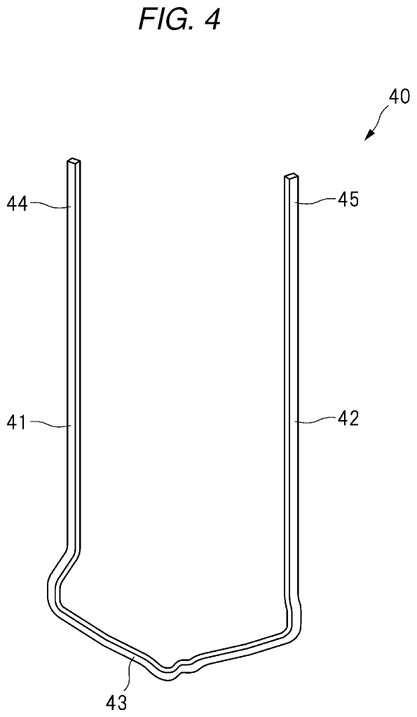

FIG. 2 is a cross-sectional view of the stator 10 taken along line A-A in FIG. 1. FIG. 3 is a cross-sectional view of the stator core 15 including a phase winding of a U phase (hereinafter referred to as U-phase coil Cu). FIG. 4 is a perspective view of one of the segment coils 40 as an example. As described later, the stator coil SC includes a phase winding of a V phase (hereinafter referred to as V-phase coil Cv) and a phase winding of a W phase (hereinafter referred to as W-phase coil Cw) as well as the U-phase coil Cu. The U-phase coil Cu, the V-phase coil Cv, and the W-phase coil Cw in the drawings have an identical coil configuration, and are wound on the stator core 15 and have phases displaced from one another by 120°.

As illustrated in FIG. 2, plural slots S1 to S48 are formed in an inner peripheral portion of the stator core 15 of the hollow cylindrical shape at predetermined intervals in a circumferential direction. Each of the slots S1 to S48 contains the segment coils 40. The plural segment coils 40 are coupled to one another to constitute the stator coil SC. In one example, the segment coils 40 may serve as “segment conductors”. As illustrated in FIGS. 2 and 3, the segment coils 40 that constitute the U-phase coil Cu are held in the slots S1, S2, S7, S8 . . . , the segment coils 40 that constitute the V-phase coil Cv are held in the slots S3, S4, S9, S10 . . . , and the segment coils 40 that constitute the W-phase coil Cw are held in the slots S5, S6, S11, S12 . . . .

As illustrated in FIG. 4, each of the segment coils 40 bent substantially in the U shape includes a coil side 41 held in one of the slots (e.g., the slot S1), and a coil side 42 held in another slot (e.g., the slot S7) at a predetermined coil pitch. The segment coil 40 also includes an end portion 43 that couples the pair of coil sides 41 and 42 to each other, and joint end portions 44 and 45 that respectively extend from the pair of coil sides 41 and 42. It is noted that the segment coil 40 is made of a rectangular wire of a conductive material such as copper, and that the segment coil 40 except distal ends of the joint end portions 44 and 45 is coated with an insulating film of enamel, resin or the like. The end portion 43 of the segment coil 40 is not limited to a bent shape illustrated in FIG. 4 but is bent in various shapes in accordance with an assembling position with respect to the stator core 15.

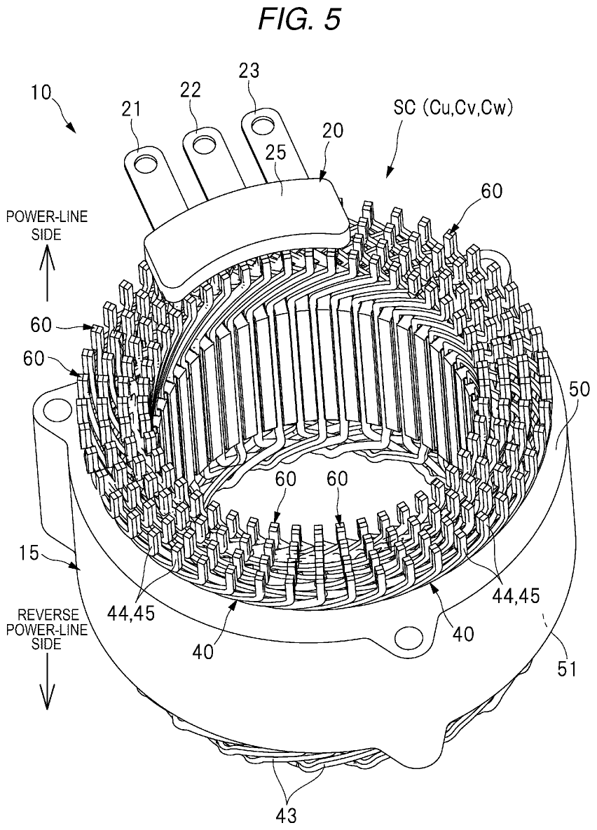

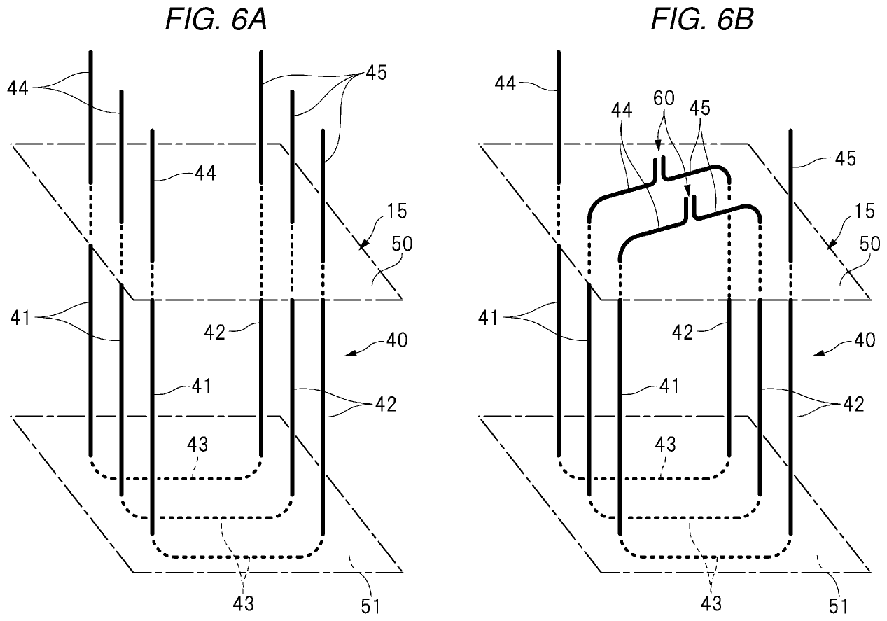

FIG. 5 is a perspective view of the stator 10. FIGS. 6A and 6B are diagrams illustrating an example of a coupling state of the segment coils 40. As illustrated in FIGS. 2 and 5, the plural segment coils 40 are assembled in each of the slots S1 to S48 of the stator core 15. As illustrated in FIGS. 5, 6A, and 6B, when the segment coils 40 are assembled with the stator core 15, the joint end portions 44 and 45 of the segment coils 40 protrude from one end surface 50 of the stator core 15 to a power-line side, and the end portions 43 of the segment coils 40 protrude from the other end surface 51 of the stator core 15 to a reverse power-line side. In one example, the one end surface 50 may serve as an “end surface”.

As illustrated in FIGS. 6A and 6B, the joint end portions 44 and 45 that protrude from the one end surface 50 of the stator core 15 are bent to come into contact with the joint end portions 44 and 45 of other segment coils 40 and become conductor joint portions 60. Then, the individual conductor joint portions 60 undergo TIG welding, for example, so as to couple the plural segment coils 40 to each other with the conductor joint portions 60. That is, the plural segment coils 40 constitute the U-phase coil Cu, the plural segment coils 40 constitute the V-phase coil Cv, and the plural segment coils 40 constitute the W-phase coil Cw. It is noted that the joint end portions 44 and 45 after welded undergo insulating processing to form a resin film, for example, to coat the conductor.

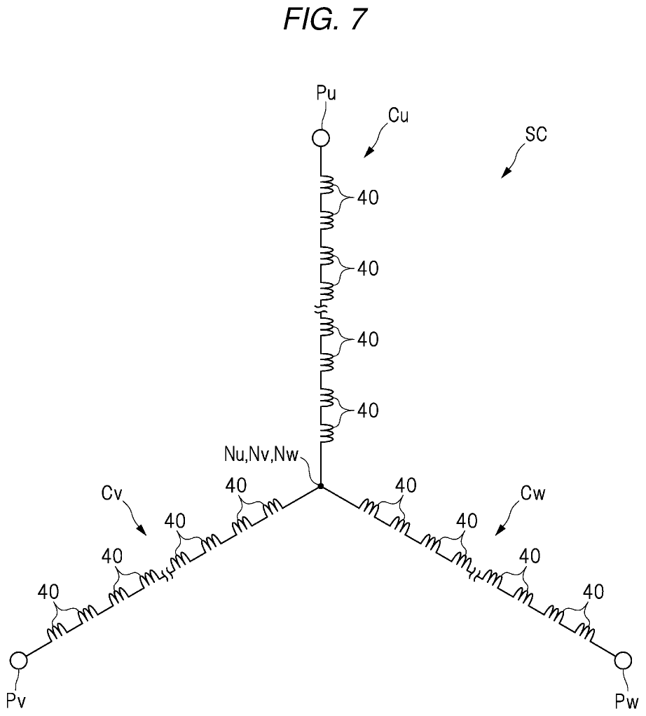

FIG. 7 is a diagram illustrating an example of a connection state of the stator coil SC. As illustrated in FIG. 7, the U-phase coil Cu, the V-phase coil Cv, and the W-phase coil Cw constitute the stator coil SC. The U-phase coil Cu includes the plural segment coils 40 connected to one another in series. One end of the U-phase coil Cu serves as a power point Pu, and the other end of the U-phase coil Cu serves as a neutral point Nu. The V-phase coil Cv includes the plural segment coils 40 connected to one another in series . One end of the V-phase coil Cv serves as a power point Pv, and the other end of the V-phase coil Cv serves as a neutral point Nv. The W-phase coil Cw includes the plural segment coils 40 connected to one another in series. One end of the W-phase coil Cw serves as a power point Pw, and the other end of the W-phase coil Cw serves as a neutral point Nw. The neutral point Nu of the U-phase coil Cu, the neutral point Nv of the V-phase coil Cv, and the neutral point Nw of the W-phase coil Cw are coupled to one another. These phase coils Cu, Cv, and Cw constitute the stator coil SC.

### Manufacturing Method

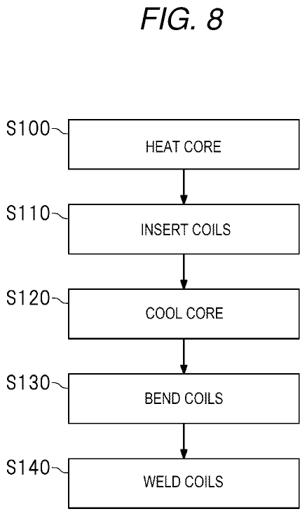

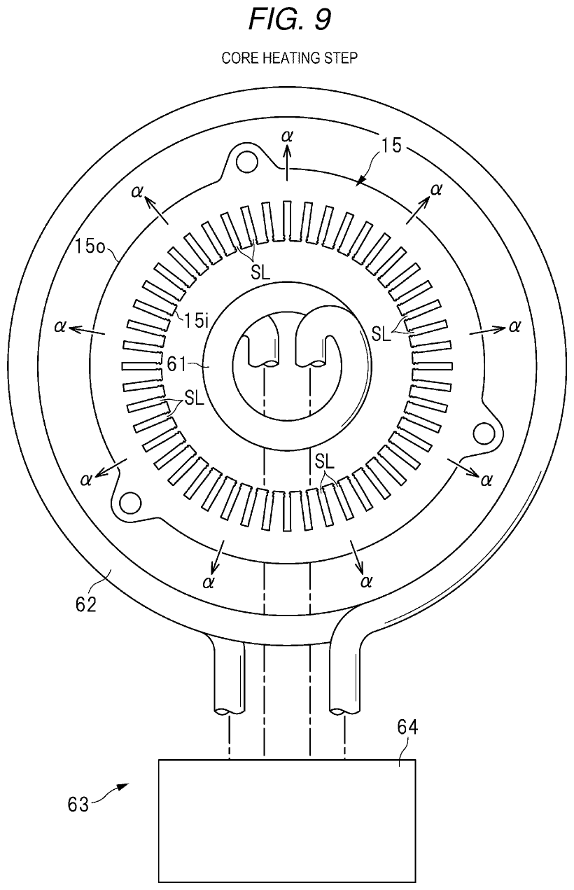

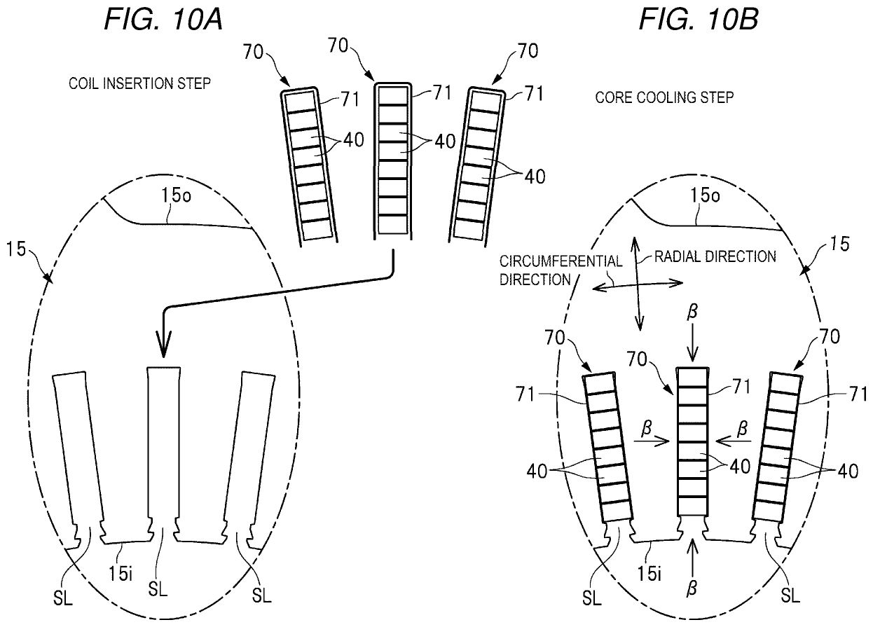

Next, a manufacturing method of the stator 10 according to an embodiment of the disclosure will be described. FIG. 8 is a flowchart of an example of the manufacturing method of the stator 10. FIG. 9 is a diagram illustrating how a core heating step S100 is performed. FIG. 10A is a partial enlarged view illustrating how a coil insertion step S110 is performed. FIG. 10B is a partial enlarged view illustrating how a core cooling step S120 is performed.

As illustrated in FIG. 8, a manufacturing procedure of the stator 10 includes the core heating step S100 of heating and expanding the stator core 15, the coil insertion step S110 of inserting the segment coils 40 in the expanded stator core 15, and the core cooling step S120 of cooling the stator core 15 where the segment coils 40 are inserted. It is noted that in the following description, the plural slots S1 to S48 formed in the stator core 15 will be described as slots SL denoted by a common reference symbol “SL”.

As illustrated in FIG. 9, at the core heating step S100, a high-frequency heater 63 including an inner coil 61 and an outer coil 62 is used to heat the stator core 15 by electromagnetic induction heating. The high-frequency heater 63 includes the inner coil 61 opposed to an inner peripheral surface 15i of the stator core 15, the outer coil 62 opposed to an outer peripheral surface 15o of the stator core 15, and a high-frequency inverter 64 to generate an alternating current. The high-frequency inverter 64 supplies the alternating current to both of the inner coil 61 and the outer coil 62 so that the stator core 15 is heated by an eddy current generated in the stator core 15. In this manner, the stator core 15 is heated by the high-frequency heater 63 so that the stator core 15 can be expanded in radial directions as indicated with arrows a to enlarge the slots SL of the stator core 15. Since the stator core 15 is heated from both of the inner peripheral surface 15i and the outer peripheral surface 15o, the stator core 15 can be wholly expanded to prevent the slots SL from partially deformed.

After the slots SL are enlarged in this manner at the core heating step S100, the procedure proceeds to the coil insertion step S110 so as to insert coil groups 70 in the enlarged slots SL as illustrated in FIG. 10A. In one example, the coil groups 70 may serve as “conductor groups”. Each of the coil groups 70 inserted into the slots SL here includes eight segment coils 40 inserted in each of the slots SL, and an insulating sheet 71 to encapsulate these segment coils 40. At the coil insertion step S110 after the slots SL are enlarged at the core heating step S100, the coil groups 70 can be accordingly easily inserted in the slots SL. It is noted that as the insulating sheet 71 interposed between the slot SL and the segment coils 40, an aramid sheet, for example, may be used, and a combination sheet of the aramid sheet and a polyester film, for example, may be used. The insulating sheet 71 is also referred to as “insulator”.

Next, after the coil groups 70 are inserted in the slots SL at the coil insertion step S110, the procedure proceeds to the core cooling step S120 so as to cool the stator core 15 together with the inserted coil groups 70 as illustrated in FIG. 10B. In this manner, the stator core 15 is cooled and contracted so that the slots SL can be reduced in size in both of the radial directions and circumferential directions of the stator core 15 as indicated with arrows β. As a result, the coil groups 70 can be tightened by the slots SL so as to secure the coil groups 70 to the stator core 15. It is noted that at the core cooling step S120, the stator core 15 may be left in a normal-temperature atmosphere or may be positively cooled by cooling winds.

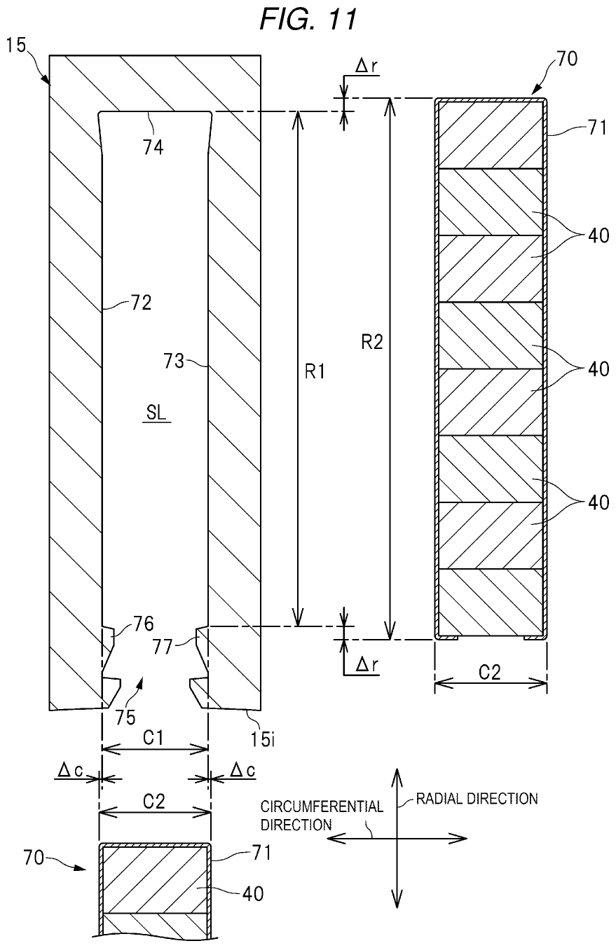

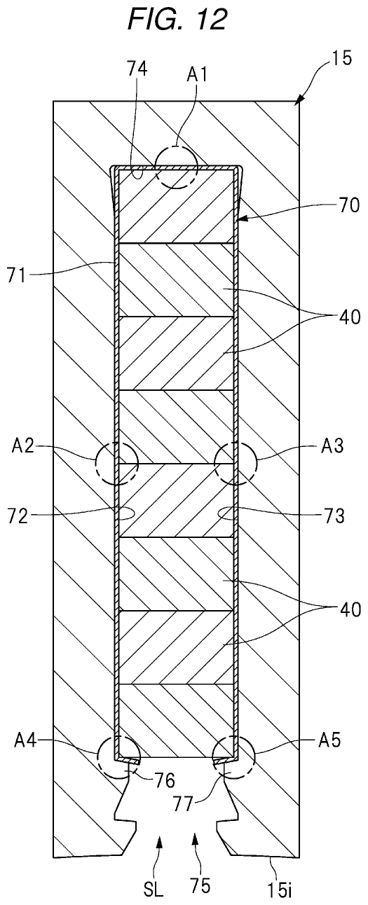

FIG. 11 is a partial enlarged view illustrating dimensions of the slot SL and the coil group 70 as single bodies in a normal-temperature environment. It is noted that radial directions and circumferential directions in FIG. 11 are the radial directions and the circumferential directions of the stator core 15. FIG. 12 is a partial enlarged view of the slot SL and the coil group 70 held in this slot SL in the normal-temperature environment. As illustrated in FIG. 11, the slot SL formed as a groove in the stator core 15 includes a pair of slot side surfaces 72 and 73 in parallel to each other, a slot bottom surface 74 perpendicular to the pair of slot side surfaces 72 and 73, and a slot opening 75 open toward the inner peripheral surface 15i of the stator core 15. The slot opening 75 includes retaining protrusions 76 and 77 to retain the coil group 70 within the slot SL. The coil group 70 held in the slot SL includes the eight segment coils 40 adjacent to each other, and the insulating sheet 71 to encapsulate these segment coils 40.

As illustrated in FIG. 11, in the normal-temperature environment, a dimension of the slot SL in the radial direction, namely, a length R1 from the slot bottom surface 74 to the retaining protrusions 76 and 77 is smaller than a dimension of the coil group 70 in the radial direction, namely, a length R2 from one end to the other end of the coil group 70 in the radial direction. In other words, when the stator core 15 is contracted at the core cooling step S120, an interference Δr is provided between the slot SL and the coil group 70 in the radial direction of the stator core 15. Moreover, in the normal-temperature environment, a dimension of the slot SL in the circumferential direction, namely, a length C1 from the slot side surface 72 on one side to the slot side surface 73 on the other side is smaller than a dimension of the coil group 70 in the circumferential direction, namely, a length C2 from one end to the other end of the coil group 70 in the circumferential direction. In other words, when the stator core 15 is contracted at the core cooling step S120, an interference Δc is provided between the slot SL and the coil group 70 in the circumferential direction of the stator core 15.

As described above, when the stator core 15 is contracted at the core cooling step S120, the interferences Δr and Δc are provided between the slot SL and the coil group 70 in both of the radial direction and the circumferential direction of the stator core 15 so that the coil group 70 can be in close contact with the stator core 15. That is, as indicated with reference symbols A1 to A5 in FIG. 12, the slot bottom surface 74, the slot side surfaces 72 and 73, and the retaining protrusions 76 and 77 can be in close contact with a perimeter of the coil group 70. This makes it possible to secure the coil group 70 to a substantially entire area of the slot SL. In this manner, the coil group 70 can be secured to the stator core 15 at a position over the substantially entire area of the slot SL so as to prevent a deviation in natural frequency of the stator 10 as described later.

As illustrated in FIG. 8, in the manufacturing procedure of the stator 10, the core cooling step S120 is followed by a coil bending step S130 of bending joint end portions of the segment coils 40. At the coil bending step S130, as illustrated in FIGS . 5 and 6B, the joint end portions 44 and 45 of the segment coils 40 that protrude from the one end surface 50 of the stator core 15 are bent in such a manner that the joint end portions 44 and 45 of the segment coils 40 form the plural conductor joint portions 60. In one example, the joint end portions 44 and 45 may serve as “end portions”. Furthermore, as illustrated in FIG. 8, in the manufacturing procedure of the stator 10, the coil bending step S130 is followed by a coil welding step S140 of welding the conductor joint portions 60 by TIG welding, for example. When the conductor joint portions 60 are individually welded at the coil welding step S140, the plural segment coils 40 form the stator coil SC as illustrated in FIG. 7.

As has been described so far, the stator core 15 is expanded at the core heating step S100, the coil groups 70 are inserted in the slots SL at the coil insertion step S110, and the stator core 15 is contracted at the core cooling step S120 to provide the interferences Δr and Δc between each slots SL and a respective one of the coil groups 70. As a result, the coil groups 70 can be in close contact with the stator core 15, and the coil groups 70 can be secured to the substantially entire areas of the slots SL. That is, even in the case of mass production of the stators 10 in a manufacturing line, an oscillation mode of the coil groups 70, namely, the stator coil SC can be made constant to stabilize natural frequencies of the individual stators 10 manufactured. Since the deviation in natural frequency of the stators 10 can be reduced in this manner, a scope for a designer of the whole motor can be widened. Moreover, a range of the deviation in natural frequency of the stators 10 is reduced to decrease a carrier frequency of the inverter 26 while avoiding resonance of the rotary electric machine 11. This can increase efficiency of the inverter 26, thus enhancing energy efficiency of the rotary electric machine 11. It is noted that even when a motor temperature increases in accordance with drive of the rotary electric machine 11, the slots SL and the coil groups 70 are kept in close contact with each other as illustrated in FIG. 12.

Needless to say, the disclosure is not limited to the foregoing embodiments, and various modifications can be made thereto within the scope that does not depart from the gist thereof. In the description above, the interferences Δr and Δc are set between each of the slots SL and the respective one of the coil groups 70. However, this is not to be construed in a limiting sense. For example, only the interference Δr in the radial direction of the stator core 15 maybe set between each of the slots SL and the respective one of the coil groups 70. Alternatively, only the interference Δc in the circumferential direction of the stator core 15 may be set between each of the slots SL and the respective one of the coil groups 70. That is, when the core cooling step S120 is performed, the interference in at least one of the circumferential direction or the radial direction of the stator core 15 may be provided between each of the slots SL and the respective one of the coil groups 70.

In the description above, the interferences are set between each of the slots SL and the respective one of the coil groups 70 so as to firmly secure the stator coil SC to the stator core 15. However, varnish of resin and organic solvent may be further spread through the stator coil SC and cured. In the case of spreading the varnish through the stator coil SC in this manner, a varnish spreading step may be set after the core cooling step S120 or after the coil bending step S130 or after the coil welding step S140.

In the description above, at the core heating step S100, the stator core 15 is heated from both of the inner peripheral surface 15i and the outer peripheral surface 15o. However, this is not to be construed in a limiting sense. For example, the stator core 15 may be heated only from the inner peripheral surface 15i or only from the outer peripheral surface 15o. In the description above, at the core heating step S100, the stator core 15 is heated by the high-frequency heater 63. However, this is not to be construed in a limiting sense. For example, the stator core 15 may be heated by an electric furnace. In order to facilitate insertion of the segment coils 40 in the slots SL of the stator core 15, the segment coils 40 may be cooled and contracted at the same time when the stator core 15 is heated and expanded.

In the description above, the plural segment coils 40 are connected in series to constitute each of the phase coils Cu, Cv, and Cw. However, this is not to be construed in a limiting sense. The plural segment coils 40 may be connected in parallel to constitute each of the phase coils Cu, Cv, and Cw. In the illustrated example, eight segment coils 40 are inserted into each slot SL. However, this is not to be construed in a limiting sense. For example, more than eight segment coils 40 may be inserted into each slot SL, and less than eight segment coils 40 may be inserted into each slot SL. In the description above, the stator core 15 where the number of the slots is 48 is used. However, this is not to be construed in a limiting sense. A stator core with another number of the slots may be used.

According to the embodiment of the disclosure, the stator core where the conductor groups are inserted is cooled to provide the interferences between each of the slots and the respective one of the conductor groups. This makes it possible to stabilize the natural frequency of the manufactured stator.

1. A method of manufacturing a stator for a rotary electric machine, the method comprising:
heating a stator core so as to expand the stator core, the stator core having a hollow cylindrical shape, the stator core including slots;
inserting conductor groups in the slots of the heated stator core, the conductor groups each comprising segment conductors; and
cooling the stator core where the conductor groups are inserted so as to provide an interference between each of the slots and a corresponding one of the conductor groups.

2. The method according to claim 1, wherein after the cooling, the interference is provided between each of the slots and the corresponding one of the conductor groups in at least one of a circumferential direction or a radial direction of the stator core.

3. The method according to claim 1, wherein the conductor groups each comprise the segment conductors and an insulating sheet.

4. The method according to claim 2, wherein the conductor groups each comprise the segment conductors and an insulating sheet.

5. The method according to claim 1, wherein the heating comprises heating the stator core from both of an inner peripheral surface and an outer peripheral surface of the stator core.

6. The method according to claim 2, wherein the heating comprises heating the stator core from both of an inner peripheral surface and an outer peripheral surface of the stator core.

7. The method according to claim 3, wherein the heating comprises heating the stator core from both of an inner peripheral surface and an outer peripheral surface of the stator core.

8. The method according to claim 4, wherein the heating comprises heating the stator core from both of an inner peripheral surface and an outer peripheral surface of the stator core.

9. The method according to claim 1, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.

10. The method according to claim 2, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.

11. The method according to claim 3, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.

12. The method according to claim 4, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.

13. The method according to claim 5, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.

14. The method according to claim 6, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.

15. The method according to claim 7, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.

16. The method according to claim 8, further comprising:
bending, after the cooling, end portions of the segment conductors that protrude from an end surface of the stator core so as to form conductor joint portions comprising the end portions of the segment conductors; and
welding the conductor joint portions individually so as to form a stator winding of the segment conductors.
